(19) United States
(12) Patent Application Publication
(10) Pub. No.: US 2026/0025737 A1
(43) Pub. Date: Jan. 22, 2026

(54) Handling Procedure Performed On Restricted Radio Access Technology In Mobile Communications

(71) Applicant: MediaTek Singapore Pte. Ltd., Singapore (SG)

(72) Inventors: Marko Niemi, Oulu (FI); Puneet, Bengaluru (IN)

(21) Appl. No.: 19/253,954

(22) Filed: Jun. 29, 2025

(30) Foreign Application Priority Data
Jul. 17, 2024 (IN) 202421054565

(51) Int. Cl. H04W 48/02; H04W 48/20; H04W 84/04

(52) U.S. Cl. CPC H04W 48/02; H04W 48/20; H04W 84/042

(57) ABSTRACT

Techniques pertaining to handling procedure performed on a restricted radio access technology (RAT) in mobile communications are described. An apparatus (e.g., a UE) initiates a procedure with a network. The apparatus then receives from the network, responsive to the initiating, a reject message with a cause indicating that a RAT attempted to be accessed by the apparatus is restricted. In response to receiving the reject message, the apparatus selects another RAT or a new public land mobile network (PLMN).

### CROSS REFERENCE TO RELATED PATENT APPLICATION(S)

The present disclosure claims the priority benefit of Indian Patent Application number 202421054565, filed 17 Jul. 2024, the content of which herein being incorporated by reference in its entirety.

### TECHNICAL FIELD

The present disclosure is generally related to mobile communications and, more particularly, to handling procedure performed on a restricted radio access technology (RAT) in mobile communications.

### BACKGROUND

In wireless communications such as mobile communications under the current 3^{rd} Generation Partnership Project (3GPP) specification, there is a service requirement to enable a network operator to regulate the utilization of a particular access technology combination within a public land mobile network (PLMN). However, at the time of the present disclosure, the behavior of a user equipment (UE) when a registration is performed on a restricted RAT is undefined. Therefore, there is a need for a solution of handling procedure performed on a restricted RAT in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to handling procedure performed on a restricted RAT in mobile communications. It is believed that implementations of one or more of the schemes proposed herein may address or otherwise alleviate the issues described above.

In one aspect, a method may involve a UE initiating a procedure with a network. The method may also involve the UE receiving, from the network responsive to the initiating, a reject message with a cause indicating that a RAT attempted to be accessed by the UE is restricted. The method may further involve the UE selecting another RAT or a new PLMN responsive to the receiving.

In another aspect, a method may involve a network receiving signaling from a UE to initiate a procedure with the network. The method may also involve the network determining that a RAT attempted to be accessed by the UE is part of restriction on RAT utilization. The method may additionally involve the network, responsive to the determining, transmitting a reject message to the UE with a cause indicating that the RAT is restricted.

In yet another aspect, an apparatus implementable in a UE may include a transceiver configured to communicate wirelessly and a processor coupled to the transceiver. The processor may initiate a procedure with a network. The processor may also receive, from the network responsive to the initiating, a reject message with a cause indicating that a RAT attempted to be accessed by the UE is restricted. The processor may further select another RAT or a new PLMN responsive to the receiving.

It is noteworthy that, although the description provided herein may be in the context of certain radio access technologies, networks, and network topologies such as 5^{th} Generation (5G)/New Radio (NR)/Beyond Fifth-Generation (B5G)/6^{th} Generation (6G) mobile communications, the proposed concepts, schemes and any variation(s)/derivative(s) thereof may be implemented in, for and by other types of radio access technologies, networks and network topologies such as, for example and without limitation, 4G/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system under a proposed scheme in accordance with the present disclosure.

FIG. 3 is a flowchart of a second example process under a proposed scheme in accordance with the present disclosure.

FIG. 4 is a flowchart of a second example process under a proposed scheme in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling procedure performed on a restricted RAT in mobile communications. According to the present disclosure, a number of possible solutions may be implemented separately or jointly. That is, although these possible solutions may be described below separately, two or more of these possible solutions may be implemented in one combination or another.

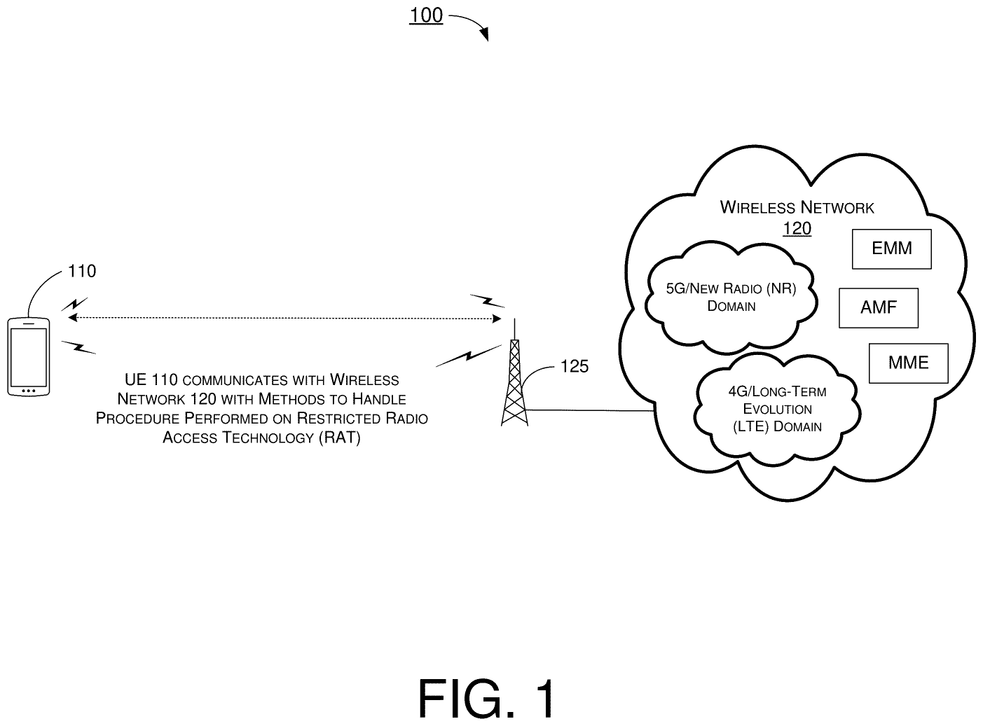

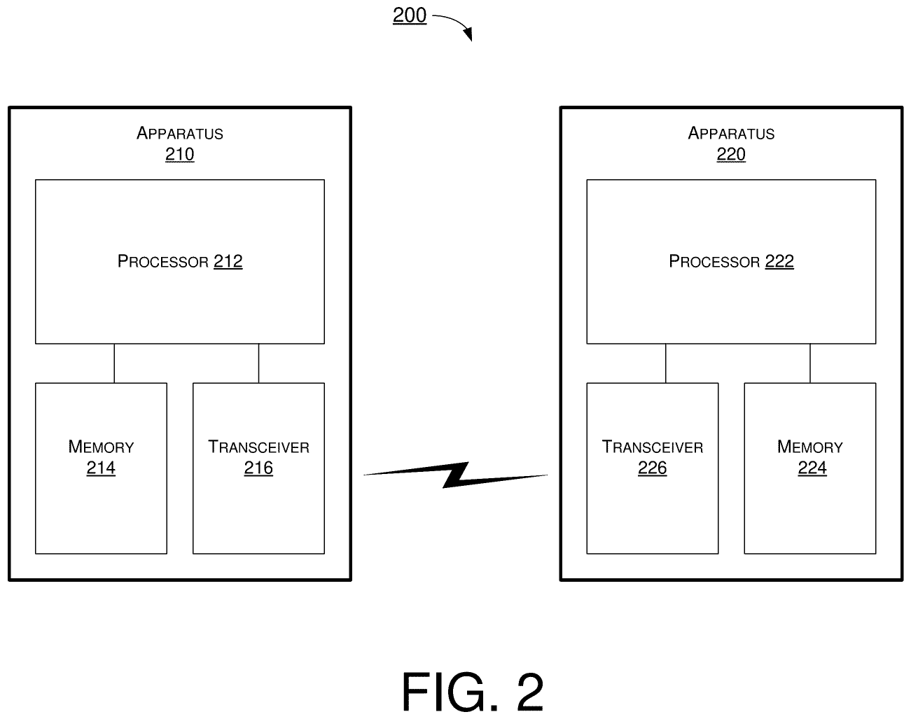

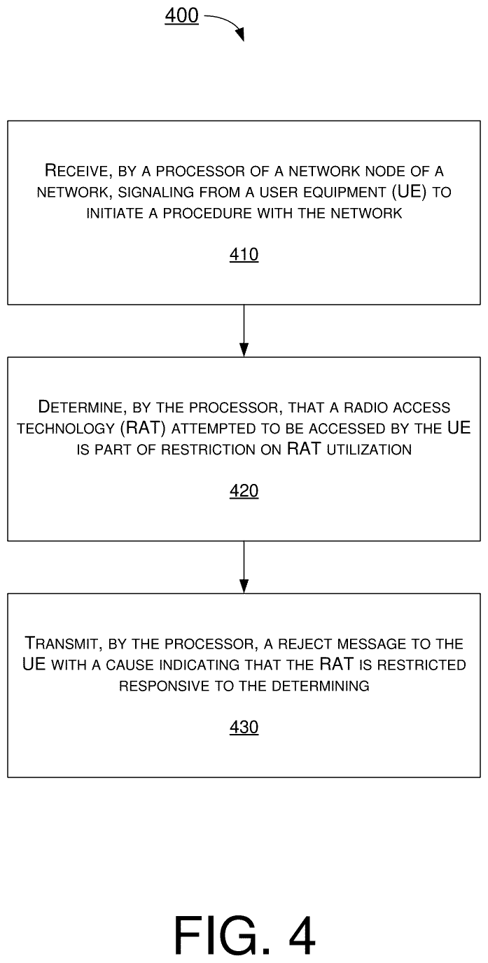

FIG. 1 illustrates an example network environment 100 in which various solutions and schemes in accordance with the present disclosure may be implemented. FIG. 2˜FIG. 4 illustrate examples of implementation of various proposed schemes in network environment 100 in accordance with the present disclosure. The following description of various proposed schemes is provided with reference to FIG. 1˜FIG. 4.

Referring to FIG. 1, network environment 100 may involve a UE 110, such as a mobile device or smartphone, in wireless communication with a wireless network 120 as part of a communication network. The wireless network 120 may be one or more public land mobile networks (PLMNs) including 5G/NR domain and/or 4G/LTE domain. Wireless network 120 may also include various functions such as, for example, Evolved Packet System (EPS) Mobility Management (EMM), Access and Mobility Management Function (AMF), and Mobility Management Entity (MME). UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to handling procedure performed on a restricted RAT in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under a proposed scheme in accordance with the present disclosure, in case that UE 110 initiates a procedure (e.g., a tracking area updating procedure, an attach procedure, a registration procedure or a service request (SR) procedure) and wireless network 120 (e.g., the EMM or AMF of the network) determines that the RAT in use by UE 110 is part of a restriction on the utilization of that RAT, then wireless network 120 may transmit or otherwise send a reject message with a new or existing 5th Generation Mobility Management (5GMM) or EMM cause value to UE 110. Additionally, wireless network 120 may transmit or send a new extended cause to UE 110 to provide additional details of the reason of rejection.

Under the proposed scheme, the reject cause and/or extended cause may indicate that the RAT attempted to be accessed is restricted in the PLMN(s) and/or tracking area identity/identities (TAI(s)) and/or registration area(s) (RA(s)) and/or cell(s) which UE 110 is attempting to access. In the reject message, wireless network 120 may also indicate whether there is/are other restricted RAT(s) on top of the very RAT that UE 110 attempted to use for access. Alternatively, or additionally, wireless network 120 may include the restricted RAT information associated with the PLMN(s)/TAI(s)/RA(s)/cell(s). Upon receiving the cause in the reject message, UE 110 may attempt to select another RAT (an allowed RAT) from the same/current PLMN, if available. Alternatively, UE 110 may perform PLMN selection in case that allowed RATs are not available in the current PLMN.

As a first implementational example, in case that UE 110 initiated a tracking area updating procedure and the MME of wireless network 120 determines that the RAT is part of restriction on the utilization of radio access technologies, then the MME may set the EMM cause value in the TRACKING AREA UPDATE REJECT message to #15 (“No suitable cells in tracking are”) and the Extended EMM cause information element (IE) with a value indicating “E-UTRAN not allowed”, and the MME may also include a list of restricted RAT(s) associated with the current PLMN.

As a second implementational example, in case a reject message received by UE 110 indicates cause #15 (no suitable cells in the tracking area), UE 110 may set a 5th Generation System (5GS) update status to 5U3 ROAMING NOT ALLOWED (and may store it according to subclause 5.1.3.2.2 of the 3GPP Technical Specification (TS). UE 110 may reset the registration attempt counter. Additionally, UE 110 may enter the state of 5GMM-REGISTERED.LIMITED-SERVICE. Moreover, in case that the Extended 5GMM cause IE with value “RAT(s) not allowed in PLMN” is included in the REGISTRATION REJECT (or ATTACH/TAU/SR REJECT) message, the message may have been successfully integrity checked by the non-access-stratum (NAS) and UE 110 may be configured for “Supporting RAT(s) restriction via NAS signalling” as specified in 3GPP TS 24.368 or 3GPP TS 31.102, then UE 110 may disable the RAT that the NAS procedure was attempted and/or RATs indicated as restricted. UE 110 may also search for a suitable cell from another/allowed RAT in the PLMN, if available, and otherwise perform a PLMN selection. Otherwise, UE 110 may ignore the Extended 5GMM cause IE and search for a suitable cell in another tracking area according to 3GPP TS 38.304 or 3GPP TS 36.304.

As a third implementational example, the REJECT message may include a new or existing reject cause value plus a new IE dedicated for indicating restricted RAT(s). The new IE may be included in a REJECT message to indicate the restricted RAT(s) associated with certain PLMN(s)/TAI(s)/RA(s)/cell(s).

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to handling procedure performed on a restricted RAT in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to handling procedure performed on a restricted RAT in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example processes 300 and 400.

### Illustrative Processes

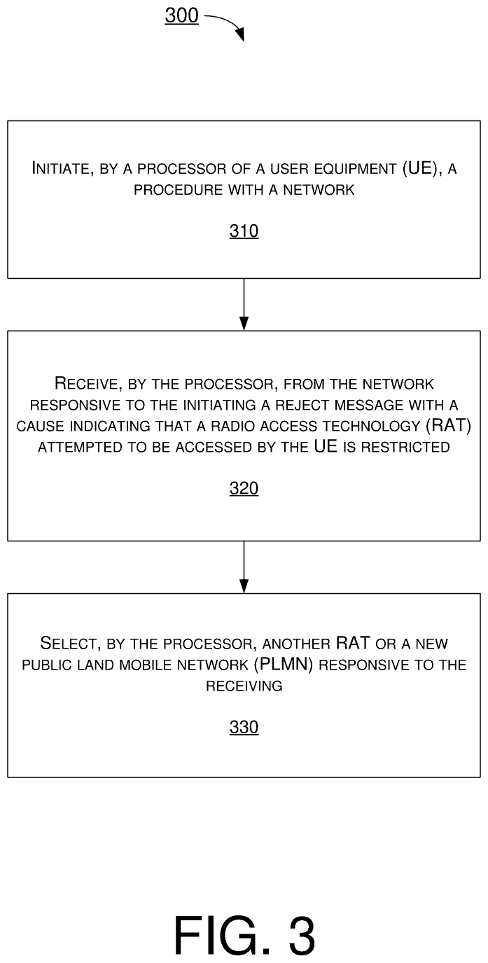

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to handling procedure performed on a restricted RAT in mobile communications in accordance with the present disclosure. Process 300 may include one or more operations, actions, or functions as illustrated by one or more of blocks 310, 320 and 330. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210, as UE 110, initiating, via transceiver 216, a procedure with a network (e.g., wireless network 120 via apparatus 220 as network node 125). Process 300 may proceed from 310 to 320.

At 320, process 300 may involve processor 212 receiving, via transceiver 216, from the network, responsive to the initiating, a reject message with a cause indicating that a RAT attempted to be accessed by apparatus 210 is restricted. Process 300 may proceed from 320 to 330.

At 330, process 300 may involve processor 212 selecting, via transceiver 216, another RAT or a new public land mobile network (PLMN) responsive to the receiving.

In some implementations, the cause may indicate that the RAT attempted to be access by the UE is restricted in a PLMN, TAI, RA, or cell which the UE is attempting to access.

In some implementations, the cause may include a new or existing cause value and an IE (e.g., a new IE) indicating one or more restricted RATs associated with one or more PLMNs, one or more TAIs, one or more RAs, or one or more cells.

In some implementations, the IE may also indicate whether there are one or more other restricted RATs in addition to the RAT attempted to be access by the UE.

In some implementations, the IE may also indicate information of one or more other restricted RATs associated with the PLMN, TAI, RA, or cell which the UE is attempting to access.

In some implementations, the cause value may include a new or existing 5GMM or EMM cause value.

In some implementations, in initiating the procedure, process 300 may involve processor 212 initiating a tracking area updating procedure, an attach procedure, a registration procedure or a service request procedure.

In some implementations, in selecting the another RAT or the new PLMN, process 300 may involve processor 212 selecting the another RAT, which is allowed to be accessed by the UE, from the same PLMN the UE is attempting to access.

In some implementations, in selecting the another RAT or the new PLMN, process 300 may involve processor 212 performing a PLMN selection in an event that there is no allowed RAT available in the current PLMN.

FIG. 4 illustrates an example process 400 in accordance with an implementation of the present disclosure. Process 400 may represent an aspect of implementing various proposed designs, concepts, schemes, systems and methods described above. More specifically, process 400 may represent an aspect of the proposed concepts and schemes pertaining to handling procedure performed on a restricted RAT in mobile communications in accordance with the present disclosure. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively, in a different order. Furthermore, one or more of the blocks/sub-blocks of process 400 may be executed repeatedly or iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125) of a network (e.g., wireless network 120). Process 400 may begin at block 410.

At 410, process 400 may involve processor 222 of apparatus 220, as network node 125, receiving, via transceiver 226, signaling from a UE (e.g., apparatus 210) to initiate a procedure with the network. Process 400 may proceed from 410 to 420.

At 420, process 400 may involve processor 222 determining that a RAT attempted to be accessed by the UE is part of restriction on RAT utilization. Process 400 may proceed from 420 to 430.

At 430, process 400 may involve processor 222 transmitting, via transceiver 226, a reject message to the UE with a cause indicating that the RAT is restricted responsive to the determining.

In some implementations, the cause may indicate that the RAT attempted to be access by the UE is restricted in a PLMN, TAI, RA, or cell which the UE is attempting to access.

In some implementations, the cause may consist of a new or existing cause value and an IE (e.g., a new IE) indicating one or more restricted RATs associated with one or more PLMNs, one or more TAIs, one or more RAs, or one or more cells.

In some implementations, the IE may also indicate whether there are one or more other restricted RATs in addition to the RAT attempted to be access by the UE.

In some implementations, the IE may also indicate information of one or more other restricted RATs associated with the PLMN, TAI, RA, or cell which the UE is attempting to access.

In some implementations, the cause value may include a new or existing 5GMM or EMM cause value.

In some implementations, in receiving the signaling, process 400 may involve processor 222 receiving the signaling to initiate a tracking area updating procedure, an attach procedure, a registration procedure or a service request procedure.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
initiating, by a processor of a user equipment (UE), a procedure with a network;
receiving, by the processor, from the network responsive to the initiating a reject message with a cause indicating that a radio access technology (RAT) attempted to be accessed by the UE is restricted; and
selecting, by the processor, another RAT or a new public land mobile network (PLMN) responsive to the receiving.

2. The method of claim 1, wherein the cause indicates that the RAT attempted to be access by the UE is restricted in a PLMN, tracking area identity (TAI), registration area (RA), or cell which the UE is attempting to access.

3. The method of claim 1, wherein the cause comprises a new or existing cause value and an information element (IE) indicating one or more restricted RATs associated with one or more PLMNs, one or more tracking area identities (TAIs), one or more registration areas (RAs), or one or more cells.

4. The method of claim 3, wherein the IE also indicates whether there are one or more other restricted RATs in addition to the RAT attempted to be access by the UE.

5. The method of claim 3, wherein the IE also indicates information of one or more other restricted RATs associated with the PLMN, TAI, RA, or cell which the UE is attempting to access.

6. The method of claim 1, wherein the cause value comprises a new or existing 5^{th} Generation Mobility Management (5GMM) or Evolved Packet System (EPS) Mobility Management (EMM) cause value.

7. The method of claim 1, wherein the initiating of the procedure comprises initiating a tracking area updating procedure, an attach procedure, a registration procedure or a service request (SR) procedure.

8. The method of claim 1, wherein the selecting of the another RAT or the new PLMN comprises selecting the another RAT, which is allowed to be accessed by the UE, from a same PLMN the UE is attempting to access.

9. The method of claim 1, wherein the selecting of the another RAT or the new PLMN comprises performing a PLMN selection in an event that there is no allowed RAT available in a current PLMN.

10. A method, comprising:
receiving, by a processor of a network node of a network, signaling from a user equipment (UE) to initiate a procedure with the network;
determining, by the processor, that a radio access technology (RAT) attempted to be accessed by the UE is part of restriction on RAT utilization; and
transmitting, by the processor, a reject message to the UE with a cause indicating that the RAT is restricted responsive to the determining.

11. The method of claim 10, wherein the cause indicates that the RAT attempted to be access by the UE is restricted in a PLMN, tracking area identity (TAI), registration area (RA), or cell which the UE is attempting to access.

12. The method of claim 10, wherein the cause comprises a new or existing cause value and an information element (IE) indicating one or more restricted RATs associated with one or more PLMNs, one or more tracking area identities (TAIs), one or more registration areas (RAs), or one or more cells.

13. The method of claim 12, wherein the IE also indicates whether there are one or more other restricted RATs in addition to the RAT attempted to be access by the UE.

14. The method of claim 12, wherein the IE also indicates information of one or more other restricted RATs associated with the PLMN, TAI, RA, or cell which the UE is attempting to access.

15. The method of claim 10, wherein the cause value comprises a new or existing 5^{th} Generation Mobility Management (5GMM) or Evolved Packet System (EPS) Mobility Management (EMM) cause value.

16. The method of claim 10, wherein the receiving of the signaling comprises receiving the signaling to initiate a tracking area updating procedure, an attach procedure, a registration procedure or a service request (SR) procedure.

17. An apparatus implementable in a user equipment (UE), comprising:
a transceiver configured to communicate wirelessly; and
a processor coupled to the transceiver and configured to perform operations comprising:
initiating, via the transceiver, a procedure with a network;
receiving, via the transceiver, from the network responsive to the initiating a reject message with a cause indicating that a radio access technology (RAT) attempted to be accessed by the UE is restricted; and
selecting, via the transceiver, another RAT or a new public land mobile network (PLMN) responsive to the receiving.

18. The apparatus of claim 17, wherein the cause comprises a new or existing cause value and an information element (IE) indicating one or more restricted RATs associated with one or more PLMNs, one or more tracking area identities (TAIs), one or more registration areas (RAs), or one or more cells.

19. The apparatus of claim 17, wherein the initiating of the procedure comprises initiating a tracking area updating procedure, an attach procedure, a registration procedure or a service request (SR) procedure.

20. The apparatus of claim 17, wherein the selecting of the another RAT or the new PLMN comprises:
selecting the another RAT, which is allowed to be accessed by the UE, from a same PLMN as a current PLMN on which the UE is currently camped; or
performing a PLMN selection in an event that there is no allowed RAT available in the current PLMN.
